(19) United States
(12) Patent Application Publication
(10) Pub. No.: US 2026/0299843 A1
(43) Pub. Date: Oct. 1, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventors: HIROYOSHI IWAYAMA, Kanagawa (JP); KEISUKE MIZUTANI, Kanagawa (JP); TAKESHI HAYAKAWA, Kanagawa (JP)

(21) Appl. No.: 19/574,031

(22) Filed: Mar. 20, 2026

(30) Foreign Application Priority Data
Mar. 28, 2025 (JP) 2025-055315

(51) Int. Cl. G06F 3/12; G06Q 30/0241

(52) U.S. Cl. CPC G06F 3/1207; G06F 3/121; G06F 3/1259; G06Q 30/0276; G06F 3/1286; G06F 3/1287; G06F 3/1292

(57) ABSTRACT

Provided is a non-transitory computer-readable storage medium storing a predetermined application program for causing a computer of an information processing apparatus to receive, from a printer, information regarding a state of printing based on a print job for causing the printer to execute printing, and execute a predetermined notification process for displaying, via a push notification function, a notification area for issuing a notification indicating that the printing is being executed, the notification area including a progress bar corresponding to the printing, wherein the predetermined notification process includes a process for displaying one or more marks on the progress bar corresponding to the printing so that the progress bar corresponding to the printing is divided into a number of parts equal to a number of pieces of print data included in the print job.

### BACKGROUND

### Field of the Technology

The present disclosure relates to an information processing apparatus, a control method, and a storage medium.

### Description of the Related Art

A form is known in which an information processing apparatus such as a smartphone or the like issues notifications regarding communication with a communication apparatus such as a printer or the like and processing executed by the communication apparatus. Japanese Patent Laid-Open No. 2021-071871 describes a technique in which an information processing apparatus issues a notification regarding printing executed by a communication apparatus by a push notification function.

Incidentally, with the prevalence of a form in which a notification by a push notification function is issued, it is desired to make it easy for a user to recognize information conveyed via a push‑notification function.

### SUMMARY

The present disclosure is directed to making it easier for a user to recognize information conveyed via a push‑notification function..

According to an aspect of the present disclosure, a non-transitory computer-readable storage medium storing a predetermined application program for causing a computer of an information processing apparatus to receive, from a printer, information regarding a state of printing based on a print job for causing the printer to execute printing, and execute a predetermined notification process for displaying, via a push notification function, a notification area for issuing a notification indicating that the printing is being executed, the notification area including a progress bar corresponding to the printing, wherein the predetermined notification process includes a process for displaying one or more marks on the progress bar corresponding to the printing so that the progress bar corresponding to the printing is divided into a number of parts equal to a number of pieces of print data included in the print job.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a communication system.

FIG. 2 is an example of a diagram illustrating configurations of a terminal apparatus and a communication apparatus.

FIG. 3 is a flowchart illustrating a print job transmission process.

FIG. 4 is a flowchart illustrating a process for notifying a user of job-related information.

FIG. 5 is a flowchart illustrating a process for updating notification content.

FIGS. 6A to 6H are examples of notification areas displayed on an application screen.

FIGS. 7A to 7H are examples of push notification areas.

FIGS. 8A to 8H are examples of push notification areas.

FIGS. 9A and 9B are examples of push notification areas.

### DESCRIPTION OF THE EMBODIMENTS

### First Embodiment

A description is given of an information processing apparatus and a communication apparatus included in a communication system according to a first embodiment. The information processing apparatus is also referred to as a "terminal apparatus". Although in the present embodiment, a smartphone is illustrated as an example of the information processing apparatus, the present disclosure is not limited to this. As the information processing apparatus, various apparatuses such as a personal computer (PC), a tablet terminal, a personal digital assistant (PDA), a digital camera, and the like are applicable. In the present embodiment, a printer is illustrated as an example of the communication apparatus. The printer may be an inkjet printer that performs printing using ink, or may be a laser beam printer that performs printing using toner. The printer may be a full-color printer capable of color printing, or may be a monochrome printer incapable of color printing and capable of monochrome printing. In the present embodiment, the communication apparatus is not limited to a printer, and any apparatus can be applied as the communication apparatus so long as the apparatus can wirelessly communicate with the information processing apparatus. The communication apparatus is applicable to, for example, a copying machine, a facsimile apparatus, a scanner, a smartphone, a laptop PC, a tablet terminal, a PDA, a digital camera, a music reproduction device, a television, a smart speaker, a robotic vacuum cleaner, an automatic cooker, a refrigerator, and the like. Additionally, the communication apparatus is also applicable to a multifunction peripheral having a plurality of functions such as a copy function, a fax function, a print function, and the like.

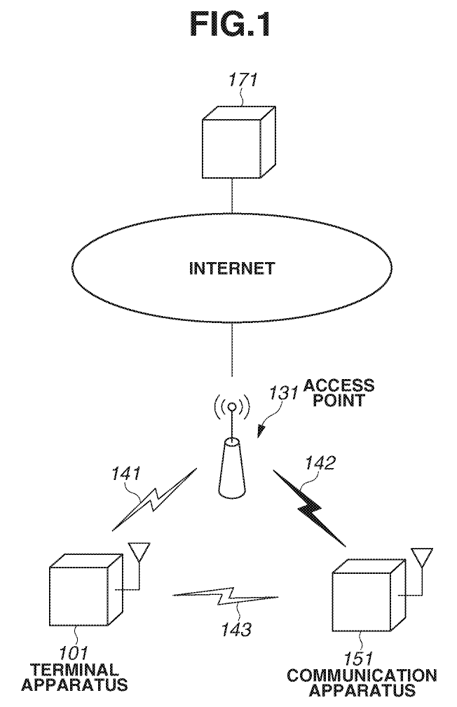

First, a system configuration for achieving the present embodiment is described. FIG. 1 is a diagram illustrating an example of the configuration of the communication system according to the present embodiment. This system includes a communication apparatus 151, a terminal apparatus 101, an access point (AP) 131, and an external server 171.

The terminal apparatus 101 is the information processing apparatus according to the present embodiment. The communication apparatus 151 is the communication apparatus according to the present embodiment. The AP 131 is an access point started by an external apparatus present outside the terminal apparatus 101 and outside the communication apparatus 151. For example, the external apparatus is a local area network (LAN) router. The external server 171 is a server capable of providing a service via the Internet to an apparatus connected to the AP 131.

In the situation where the communication apparatus 151 and the terminal apparatus 101 are connected to the AP 131, a LAN formed by the AP 131 includes the AP 131, the communication apparatus 151, and the terminal apparatus 101. On the other hand, a wide area network (WAN) includes the AP 131 and the external server 171.

In the present embodiment, if an infrastructure connection is established, the terminal apparatus 101 can communicate with the communication apparatus 151 via the AP 131. Further, if a direct connection is established, the terminal apparatus 101 can directly communicate with the communication apparatus 151 not via the AP 131. In the following description, a connection with an AP is equivalent to a connection with a network formed by the AP. A single external apparatus may start a plurality of APs, and the single external apparatus may be able to simultaneously form a plurality of networks.

In the present embodiment, a connection 141 between the terminal apparatus 101 and the AP 131 and a connection 142 between the communication apparatus 151 and the AP 131 are connections using a communication method based on the Institute of Electrical and Electronics Engineers (IEEE) 802.11 series standard. Specifically, the communication method based on the IEEE 802.11 series standard is Wireless Fidelity (Wi-Fi) (registered trademark). A connection 143 between the terminal apparatus 101 and the communication apparatus 151 is also a connection using the communication method based on the IEEE 802.11 series standard. However, the communication method used for the connection 143 is not limited to this form, and for example, may be Bluetooth® Low Energy, Bluetooth® Classic, Wi-Fi Aware, near-field communication (NFC), or the like. The AP 131 and the external server 171 can communicate with each other via the Internet, and in the state where the AP 131 is connected to the Internet, an apparatus (the terminal apparatus 101 or the communication apparatus 151) connected to the AP 131 can also use the Internet. The connection 141 between the terminal apparatus 101 and the AP 131 and the connection 142 between the communication apparatus 151 and the AP 131 may be connections using a wired LAN.

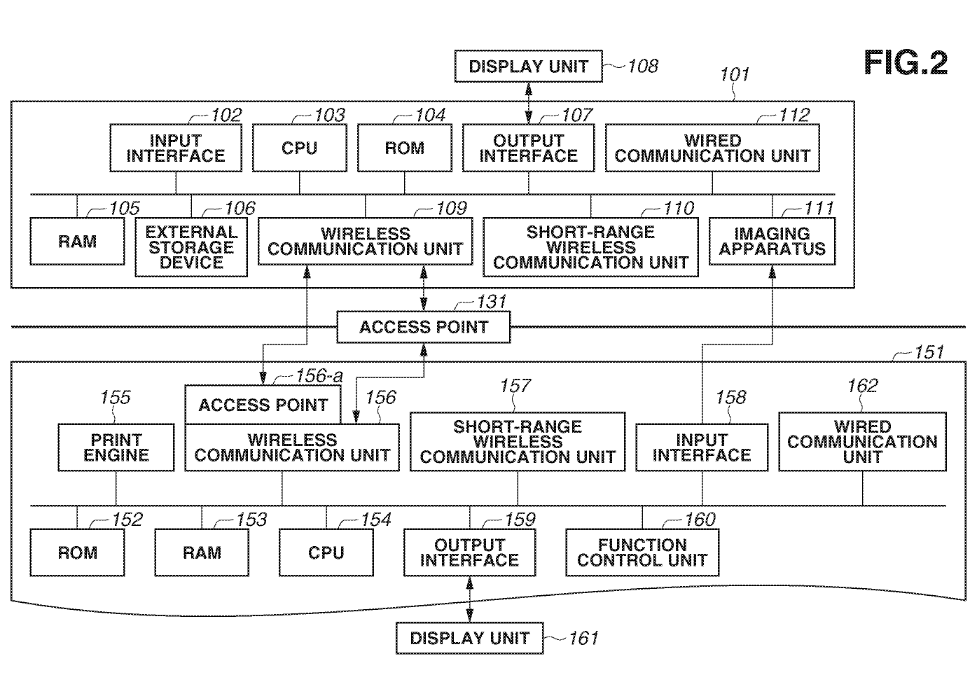

Next, with reference to a block diagram in FIG. 2, a description is given of the configurations of the information processing apparatus according to the present embodiment and the communication apparatus capable of communicating with the information processing apparatus according to the present embodiment. Although the present embodiment is described taking the following configurations as examples, the present embodiment is applicable to an apparatus capable of communicating with the communication apparatus, and functions are not particularly limited as illustrated in FIG. 2.

The terminal apparatus 101 includes an input interface 102, a central processing unit (CPU) 103, a read-only memory (ROM) 104, a random-access memory (RAM) 105, an external storage device 106, an output interface 107, a display unit 108, a wireless communication unit 109, a short-range wireless communication unit 110, an imaging apparatus 111, a wired communication unit 112, and the like. The CPU 103, the ROM 104, the RAM 105, and the like form a computer of the terminal apparatus 101.

The input interface 102 is an interface for receiving the input of data or an operation instruction from a user and is composed of a physical keyboard, a button, a touch panel, and the like. Alternatively, a form may be employed in which the output interface 107 and the input interface 102 are the same component, and the same component outputs a screen and receives an operation from the user.

The CPU 103 is a system control unit and controls the entirety of the terminal apparatus 101. In the present embodiment, the CPU 103 executes control of the display content (display control) of the display unit 108, and the like.

The ROM 104 stores fixed data such as control programs executed by the CPU 103, a data table, an operating system (hereinafter referred to as "OS") program, and the like. In the present embodiment, the control programs stored in the ROM 104 control the execution of software such as scheduling, a task switch, an interrupt process, and the like under control of the embedded OS stored in the ROM 104. In the present embodiment, the ROM 104 stores a predetermined application program (application) for controlling the communication apparatus 151. In other words, an application program is application software. For example, the predetermined application is externally installed on the terminal apparatus 101 by a store application for installing various apps. The predetermined application is an application provided by the vendor of the communication apparatus 151 and is an application for communicating with the communication apparatus 151 and making a connection setting of the communication apparatus 151. The predetermined application may have another function other than the function of making a connection setting of the communication apparatus 151. Specifically, for example, another function is the function of transmitting a print job for causing the communication apparatus 151 to execute printing (a print job transmission function), or the function of transmitting a scan job for causing the communication apparatus 151 to execute scanning (a scan job transmission function). To be exact, a process described as a process executed by the OS in the present embodiment is a process executed by the CPU 103 according to a program in the OS. Similarly, to be exact, a process described as a process executed by the application is a process executed by the CPU 103 according to a program in the app.

The RAM 105 is composed of a static random-access memory (SRAM), which requires a backup power supply, or the like. In the RAM 105, data is held by a primary battery for data backup (not illustrated). Thus, the RAM 105 can store important data such as a program control variable or the like without volatilizing the data. A memory area that stores setting information regarding the terminal apparatus 101, management data of the terminal apparatus 101, and the like is also provided in the RAM 105. The RAM 105 is also used as a main memory and a work memory for the CPU 103.

The external storage device 106 includes various programs such as a print information generation program for generating print information that can be interpreted by the communication apparatus 151, an information transmission/reception control program for transmitting and receiving information to and from the communication apparatus 151 connected to the terminal apparatus 101 via the wireless communication unit 109, and the like. The external storage device 106 also saves various pieces of information used by these programs and image data obtained from another information processing apparatus or the Internet.

The output interface 107 is an interface that controls the display unit 108 to display data or issue a notification of the state of the terminal apparatus 101.

The display unit 108 includes a light-emitting diode (LED), a liquid crystal display (LCD), or the like. The display unit 108 displays data or issues a notification of the state of the terminal apparatus 101. A software keyboard including keys such as a numerical input key, a mode setting key, a determination key, a cancellation key, a power key, and the like may be provided on the display unit 108, whereby an input from the user may be received through the display unit 108. In the present embodiment, the display unit 108 is a touch panel and can receive an operation using an operator such as a finger, a pen, or the like from the user.

The wireless communication unit 109 is a component for wirelessly connecting to an apparatus such as the communication apparatus 151, the AP 131, or the like and communicating data with the apparatus. For example, the wireless communication unit 109 may directly communicate with the communication apparatus 151 through wireless communication, or may communicate with the communication apparatus 151 via the AP 131 present outside the terminal apparatus 101 or the communication apparatus 151. Although in the present embodiment, Wi-Fi, which is a communication method based on the IEEE 802.11 standard, is used as the wireless communication method of the wireless communication unit 109, Bluetooth® Classic or the like may be used. In the present embodiment, a wireless LAN is a network using Wi-Fi. In the present embodiment, a connection using a method in which the terminal apparatus 101 and the communication apparatus 151 directly connect to each other not via an external AP is referred to as a "direct connection method". A connection using a method in which the terminal apparatus 101 and the communication apparatus 151 connect to each other via an external AP is referred to as an "infrastructure connection method".

The short-range wireless communication unit 110 is a component for communicating data with an apparatus such as the communication apparatus 151 or the like using a short-range wireless communication method and communicates using a communication method different from that of the wireless communication unit 109. The short-range wireless communication unit 110 can connect to a short-range wireless communication unit 157 in the communication apparatus 151. Examples of the communication method of the short-range wireless communication unit 110 include Bluetooth® Low Energy, Bluetooth® Classic, Wi-Fi Aware, NFC, and the like.

The imaging apparatus 111 is an apparatus that converts an image captured by an imaging element into digital data.

The digital data is temporarily stored in the RAM 105. Then, the digital data is converted into a predetermined image format by a program executed by the CPU 103 and is saved as image data in the external storage device 106.

The wired communication unit 112 is a component for connecting to an apparatus such as the communication apparatus 151, the AP 131, or the like by wire and communicating data with the apparatus. For example, the wired communication unit 112 communicates using the wired LAN. In the present embodiment, the wired LAN communicates based on the Ethernet standard. The present disclosure is not limited to this form, and for example, the wired communication unit 112 may communicate using a Universal Serial Bus (USB) cable. For example, if the terminal apparatus 101 is a smartphone, the terminal apparatus 101 may not include the wired communication unit 112.

The communication apparatus 151 includes a ROM 152, a RAM 153, a CPU 154, a print engine 155, a wireless communication unit 156, a short-range wireless communication unit 157, an input interface 158, an output interface 159, a function control unit 160, a display unit 161, a wired communication unit 162, and the like.

The ROM 152, the RAM 153, the CPU 154, and the like form a computer of the communication apparatus 151.

The wireless communication unit 156 is a component for wirelessly connecting to an apparatus such as the terminal apparatus 101, the AP 131, or the like and communicating data with the apparatus. Although in the present embodiment, Wi-Fi, which is a communication method based on the IEEE 802.11 standard, is used as the wireless communication method of the wireless communication unit 156, Bluetooth® Classic or the like may be used. The wireless communication unit 156 includes, as an AP inside the communication apparatus 151, an AP 156-a for connecting to an apparatus such as the terminal apparatus 101 or the like. The AP 156-a can connect to the wireless communication unit 109 of the terminal apparatus 101. The wireless communication unit 156 may directly communicate with the terminal apparatus 101 via the AP 156-a, or may communicate with the terminal apparatus 101 via the AP 131. The AP 156-a may be hardware that functions as an AP, or the wireless communication unit 156 may operate as the AP 156-a by software for functioning as an AP. The communication apparatus 151 may be able to internally start a plurality of APs having different Service Set Identifiers (SSIDs) and passwords.

The RAM 153 is composed of a dynamic random-access memory (DRAM), which requires a backup power supply, or the like. In the RAM 153, data is held by supplying power for data backup (not illustrated) to the RAM 153. Thus, the RAM 153 can store important data such as a program control variable or the like without volatilizing the data. The RAM 153 is also used as a main memory and a work memory for the CPU 154. The RAM 153 saves various pieces of information as a reception buffer for temporarily saving print information received from the terminal apparatus 101 or the like.

The ROM 152 stores fixed data such as control programs executed by the CPU 154, a data table, an OS program, and the like. In the present embodiment, the control programs stored in the ROM 152 control the execution of software such as scheduling, a task switch, an interrupt process, and the like under control of the embedded OS stored in the ROM 152. A memory area that stores data that needs to be held also in a case where power is not supplied, such as setting information regarding the communication apparatus 151, management data of the communication apparatus 151, and the like, is also provided in the ROM 152.

The CPU 154 is a system control unit and controls the entirety of the communication apparatus 151.

Based on information saved in the RAM 153 and a print job received from the terminal apparatus 101 or the like, the print engine 155 forms an image on a recording medium such as paper or the like using a recording agent such as ink or the like and outputs the printing result. At this time, the amount of transmitted data of the print job transmitted from the terminal apparatus 101 or the like is large, and therefore, high-speed communication is required. Thus, the communication apparatus 151 receives the print job via the communication unit 156, which can communicate faster than the short-range wireless communication unit 157.

The short-range wireless communication unit 157 is a component for communicating with an apparatus such as the terminal apparatus 101 or the like using a short-range wireless communication method. Examples of the communication method of the short-range wireless communication unit 157 include Bluetooth® Low Energy, Bluetooth® Classic, Wi-Fi Aware, and the like.

The input interface 158 is an interface for receiving the input of data or an operation instruction from the user and is composed of a physical keyboard, a button, a touch panel, and the like. Alternatively, a form may be employed in which the output interface 159 and the input interface 158 are the same component, and the same component outputs a screen and receives an operation from the user. The output interface 159 is an interface that controls the display unit 161 to display data or issue a notification of the state of the communication apparatus 151.

The function control unit 160 manages a functional operation regarding whether to cause the functions included in the communication apparatus 151 to simultaneously operate.

The display unit 161 includes an LED, an LCD, or the like. The display unit 161 displays data or issues a notification of the state of the communication apparatus 151. A software keyboard including keys such as a numerical input key, a mode setting key, a determination key, a cancellation key, a power key, and the like may be provided on the display unit 161, whereby an input from the user may be received through the display unit 161.

The wired communication unit 162 is a component for connecting to an apparatus such as the terminal apparatus 101, the AP 131, or the like by wire and communicating data with the apparatus. For example, the wired communication unit 162 communicates using the wired LAN. The present disclosure is not limited to this form, and for example, the wired communication unit 162 may communicate using a USB cable.

### Regarding Direct Connection Method

A "direct connection" refers to a form in which apparatuses wirelessly connect to each other directly (i.e., in a peer-to-peer manner) not via an external apparatus such as the AP 131 or the like. A direct connection is also referred to as a "peer-to-peer connection (P2P connection)". The communication apparatus 151 can operate in a mode for communicating through a direct connection (a direct connection mode) as one of connection modes. In Wi-Fi communication, there is a plurality of modes such as a software AP mode, a Wi-Fi Direct (WFD) mode, and the like as modes for communicating through a direct connection.

A mode for executing a direct connection using WFD is referred to as a "WFD mode". WFD is a standard formulated by the Wi-Fi Alliance and is a standard included in the communication standards of the IEEE 802.11 series. In the WFD mode, after a device as a communication partner is found by a search using a device search command, the roles of a P2P group owner (GO) and a P2P client are determined. Then, the remaining wireless connection process is performed. The group owner is equivalent to a Wi-Fi master station (master apparatus), and the client is equivalent to a Wi-Fi slave station (slave apparatus). For example, this role determination corresponds to GO negotiation in P2P. In the WFD mode in the state before the role determination is made, the communication apparatus 151 is neither a master station nor a slave station. Specifically, first, one device issues a device search command to a device with which to communicate, thereby searching for a device to which to connect in the WFD mode. If the other device as a communication partner is found by the search, both devices confirm information regarding services and functions that can be supplied by the other devices. This device supply information confirmation is an option and is not essential. For example, this device supply information confirmation phase corresponds to P2P provision discovery. Next, the devices confirm this device supply information with each other and determine which of the devices is to be a P2P client and which of the devices is to be a P2P group owner as the roles of the device supply information. Next, if the client and the group owner are determined, both devices exchange parameters for communicating using WFD with each other. Based on the exchanged parameters, the P2P client and the P2P group owner perform the remaining wireless connection process and an Internet Protocol (IP) connection process. In the WFD mode, the communication apparatus 151 may not execute the GO negotiation, and the communication apparatus 151 may always operate as a GO. That is, the communication apparatus 151 may operate in the WFD mode as autonomous GO mode. For example, the state where the communication apparatus 151 is operating in the WFD mode is the state where a connection using WFD is not established, but the communication apparatus 151 is operating as a GO, or the state where a connection using WFD is established, and the communication apparatus 151 is operating as a GO.

In the software AP mode, between devices (e.g., the terminal apparatus 101 and the communication apparatus 151) that communicate with each other, one device (e.g., the terminal apparatus 101) is a client that serves to request various services. Then, the other device achieves the function of an AP in Wi-Fi based on the settings of software. The software AP is equivalent to a Wi-Fi master station, and the client is equivalent to a Wi-Fi slave station. In the software AP mode, a client searches for a device as a software AP using a device search command. If a software AP is found by the search, the client and the software AP perform the remaining wireless connection process (the establishment of a wireless connection or the like) and then perform an IP connection process (the assignment of IP addresses or the like). As commands and parameters transmitted and received in a case where the client and the software AP achieve a wireless connection, those defined by the Wi-Fi standard may be used, and the commands and the parameters are not described here.

In the present embodiment, if the communication apparatus 151 establishes and maintains a direct connection, the communication apparatus 151 operates as a master station in a network to which the communication apparatus 151 belongs. The master station is an apparatus that constructs a wireless network and provides a parameter used to connect to the wireless network to a slave station. For example, the parameter used to connect to the wireless network is a parameter regarding a channel used by the master station. The slave station receives the parameter, thereby connecting to the wireless network constructed by the master station, using the channel used by the master station. In the direct connection mode, the communication apparatus 151 operates as the master station, and therefore, the communication apparatus 151 can determine which frequency band is to be used and which channel is to be used for communication in the direct connection mode. In the present embodiment, the communication apparatus 151 can use a channel corresponding to the 2.4 GHz frequency band and a channel corresponding to the 5 GHz frequency band for communication in the direct connection mode.

### Regarding Infrastructure Connection Method

An infrastructure connection is a connection form in which devices (e.g., the terminal apparatus 101 and the communication apparatus 151) that communicate with each other connect to an AP (e.g., the AP 131) that performs overall control of a network of the devices, and the devices communicate with each other via the AP. The communication apparatus 151 can also operate in a mode for communicating through an infrastructure connection (an infrastructure connection mode) as one of the connection modes.

In an infrastructure connection, each device searches for an AP using a device search command. If an AP is found by the search, the device and the AP perform the remaining wireless connection process (the establishment of a wireless connection or the like) and then perform an IP connection process (the assignment of IP addresses or the like). As commands and parameters transmitted and received in a case where the device and the AP achieve a wireless connection, those defined by the Wi-Fi standard may be used, and the commands and the parameters are not described here.

In the present embodiment, if the communication apparatus 151 operates through an infrastructure connection, the AP 131 operates as a master station, and the communication apparatus 151 operates as a slave station. That is, in the present embodiment, an "infrastructure connection" refers to a connection between the communication apparatus 151 operating as a slave station and an apparatus operating as a master station. If the communication apparatus 151 establishes an infrastructure connection with the AP 131, and the terminal apparatus 101 also establishes an infrastructure connection with the AP 131, the communication apparatus 151 and the terminal apparatus 101 can communicate with each other via the AP 131. A channel to be used for communication through the infrastructure connection is determined by the AP 131, and therefore, the communication apparatus 151 communicates through the infrastructure connection using the channel determined by the AP 131. In the present embodiment, the communication apparatus 151 can use a channel corresponding to the 2.4 GHz frequency band and a channel corresponding to the 5 GHz frequency band for communication through the infrastructure connection. The communication apparatus 151 can also use a channel corresponding to a Dynamic Frequency Selection (DFS) band in the 5 GHz frequency band for communication through the infrastructure connection. To communicate with the communication apparatus 151 via the AP 131, the terminal apparatus 101 recognizes and identifies that the communication apparatus 151 belongs to a network which is formed by the AP 131 and to which the terminal apparatus 101 belongs.

### Regarding Connection Setting Process

In the present embodiment, using wireless communication with the communication apparatus 151, the terminal apparatus 101 makes a connection setting (a network connection setting) for causing the communication apparatus 151 to operate in at least one of the infrastructure connection mode and the direct connection mode. The connection setting process in the present embodiment is executed through wireless communication and therefore is also termed "cableless setup (CLS)". Alternatively, the connection setting process may be executed through wired communication. When the predetermined application stored in the external storage device 106 or the like is started, the terminal apparatus 101 performs the connection setting process on the communication apparatus 151. The communication apparatus 151 can operate in a connection setting mode (a connection setting state), which is a mode for executing the connection setting process. The communication apparatus 151 executes the connection setting process in the state where the communication apparatus 151 is operating in the connection setting mode. The details of the connection setting mode will be described below.

To cause the communication apparatus 151 to operate in the infrastructure connection mode, the terminal apparatus 101 wirelessly transmits infrastructure setting information as setting information for causing the communication apparatus 151 to operate in the infrastructure connection mode to the communication apparatus 151. The infrastructure setting information includes information regarding the AP 131. For example, the information regarding the AP 131 is information regarding the SSID, the password, and the frequency band, and the like.

On the other hand, to cause the communication apparatus 151 to operate in the direct connection mode, the terminal apparatus 101 wirelessly transmits direct setting information as setting information for causing the communication apparatus 151 to operate in the direct connection mode to the communication apparatus 151. The direct setting information includes an instruction to enable a WFD function and cause the communication apparatus 151 to operate as a group owner, and an instruction to enable an access point setting of the communication apparatus 151. The terminal apparatus 101 acquires connection information required to make a direct connection to the communication apparatus 151 from the communication apparatus 151. The connection information for making a direct connection to the communication apparatus 151 includes information regarding the SSID, the password, and the like of the communication apparatus 151 that operates in the direct connection mode.

In the present embodiment, to transmit the infrastructure setting information or the direct setting information or acquire the information for making a direct connection to the communication apparatus 151 in the connection setting process, a direct connection for the connection setting between the terminal apparatus 101 and the communication apparatus 151 is used. Then, in the present embodiment, as the direct connection for the connection setting, the connection setting process using Wi-Fi is executed. However, for example, a wireless communication standard other than Wi-Fi, such as Bluetooth® or the like, may be used. Alternatively, as the direct connection for the connection setting, a wired communication standard such as the wired LAN, USB, or the like may be used.

After an infrastructure connection or a direct connection using Wi-Fi is established between the terminal apparatus 101 and the communication apparatus 151 by the connection setting process, the terminal apparatus 101 and the communication apparatus 151 can communicate with each other through the established connection. Specifically, for example, the terminal apparatus 101 can transmit a print job for causing the communication apparatus 151 to execute printing or a scan job for causing the communication apparatus 151 to execute scanning to the communication apparatus 151 through the established connection. Although in the present embodiment, it is possible to both cause the communication apparatus 151 to operate in the infrastructure connection mode and cause the communication apparatus 151 to operate in the direct connection mode by the connection setting process, the present disclosure is not limited to this form. For example, a form may be employed in which it is possible to only cause the communication apparatus 151 to operate in the infrastructure connection mode (i.e., it is not possible to cause the communication apparatus 151 to operate in the direct connection mode) by the connection setting process.

### Regarding Connection Setting Mode

The communication apparatus 151 can operate in a connection setting mode. For example, a trigger for the communication apparatus 151 to start operating in the connection setting mode may be the state where the user presses a button for the connection setting mode or the state where the communication apparatus 151 starts (is powered on) for the first time after the arrival of shipment. The button for the connection setting mode may be a hardware button included in the communication apparatus 151, or may be a software button displayed on the display unit 161 by the communication apparatus 151.

If the communication apparatus 151 starts operating in the connection setting mode, the communication apparatus 151 enables both Wi-Fi communication and Bluetooth® Low Energy communication. Specifically, as the process of enabling Wi-Fi communication, the communication apparatus 151 enables an AP dedicated to the connection setting mode and inside the communication apparatus 151 (a connection setting AP). Consequently, the communication apparatus 151 enters the state where the communication apparatus 151 can establish a direct connection using Wi-Fi with the terminal apparatus 101. Connection information (an SSID and a password) for connecting to the connection setting AP is held in advance in the predetermined application installed on the terminal apparatus 101. That is, the terminal apparatus 101 recognizes in advance the connection information for connecting to the connection setting AP. Thus, unlike connection information regarding an AP that is enabled in the direct connection mode, the connection information for connecting to the connection setting AP cannot be optionally changed by the user. Alternatively, a form may be employed in which an encryption method is not set for the connection setting AP, and a password is not required to connect to the AP. In the connection setting mode, the communication apparatus 151 may connect to the terminal apparatus 101 using not normal Wi-Fi but WFD. That is, the communication apparatus 151 may operate as a group owner and receive a setting command from the terminal apparatus 101 through communication using WFD. In a case where the communication apparatus 151 does not have a Bluetooth® Low Energy communication function or the like, the communication apparatus 151 may enable only Wi-Fi communication in the operation in the connection setting mode.

### Regarding Registration of Communication Apparatus in App

In the present embodiment, the predetermined application acquires information regarding the communication apparatus 151 from the communication apparatus 151 and thereby can register the communication apparatus 151 in the predetermined app.

For example, the information regarding the communication apparatus 151 is capability information regarding the communication apparatus 151, identification information (a media access control (MAC) address or the like) regarding the communication apparatus 151, model information regarding the communication apparatus 151, or the like. Specifically, the capability information regarding the communication apparatus 151 includes a list of information regarding functions with which the communication apparatus 151 is compatible, information regarding consumable products (ink and sheets) that can be used in the communication apparatus 151, information indicating the printing method of the communication apparatus 151, and the like. Then, the predetermined application selects a single apparatus as a partner in communication by the predetermined application among one or more communication apparatuses 151 registered in the predetermined app. Hereinafter, the communication apparatus 151 currently selected as the apparatus as the partner in communication by the predetermined application is referred to as the "communication apparatus 151 that is being selected". The selection of the apparatus as the partner in communication by the predetermined application may be made by receiving from the user the selection of the apparatus from among the one or more communication apparatuses 151 registered in the predetermined app, or may be automatically made according to a predetermined reference by the predetermined app. For example, the apparatus as the partner in communication by the predetermined application may be changed by receiving from the user the selection of the apparatus from among the one or more communication apparatuses 151 registered in the predetermined app. In the present embodiment, the predetermined application transmits various jobs such as a print job, a scan job, and the like to the communication apparatus 151 that is being selected. That is, the communication apparatus 151 that is being selected is an apparatus as the transmission destinations of the various jobs.

### Regarding Issues to Be Solved by Present Embodiment

As described above, the predetermined application can transmit various jobs such as a print job, a scan job, and the like. While transmitting a job, the predetermined application can display job-related information such as the progress of the transmission of the job, the progress of processing executed by the communication apparatus 151 based on the transmitted job, or the like on an application screen. However, it may take time from the start of the transmission of the job to the completion of the transmission of the job or the completion of the processing executed by the communication apparatus 151 based on the transmitted job. Thus, during the period from the start of the transmission of the job to the completion of the transmission of the job or the completion of the processing executed by the communication apparatus 151 based on the transmitted job, the user may move the predetermined application to the background. In this case, there is an issue where it is not possible to notify the user of the job-related information.

As a method for solving this issue, for example, a method for notifying the user of the job-related information using a push notification function of the OS is possible. However, the mere use of the push notification function of the OS to notify the user of the job-related information results in displaying the job-related information in simple text. Thus, there is an issue where it is difficult for the user to recognize the job-related information.

Thus, in the present embodiment, a description is given of a form in which the user is notified of the job-related information using the push notification function of the OS so that it is easier for the user to recognize the job-related information.

### Regarding Processing Executed by Predetermined Application in Present Embodiment

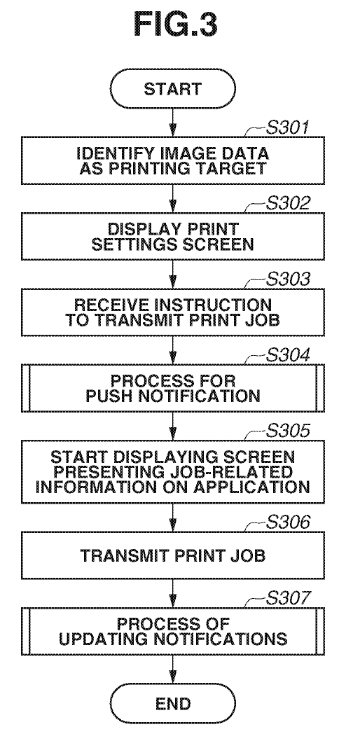

FIG. 3 is a flowchart illustrating a print job transmission process executed by the predetermined app. This flowchart is achieved by the CPU 103 reading various programs stored in a memory such as the external storage device 106 or the like into the RAM 105 and executing the various programs. Specifically, this flowchart is achieved by executing the predetermined app. This processing is started if an operation that triggers the print job transmission process is performed by the user on the screen displayed by the predetermined app.

In step S301, the CPU 103 displays a list of thumbnails corresponding to pieces of image data saved in the terminal apparatus 101. Then, the CPU 103 receives from the user the selection of one or more thumbnails from the list and identifies pieces of image data corresponding to the selected one or more thumbnails as a printing target. The list may include a thumbnail corresponding to image data received from the external server 171 via the Internet by the terminal apparatus 101. In this case, if the thumbnail is selected by the user, the CPU 103 acquires the image data corresponding to the selected thumbnail from the external server 171 via the Internet, thereby identifying the image data.

In step S302, the CPU 103 displays a print settings screen for a print job for causing the communication apparatus 151 to print images based on the one or more pieces of image data identified in step S301.

The print settings screen includes an area for previewing the images based on the one or more pieces of image data identified in step S301, an area for receiving changes in print settings from the user, and an area for receiving an instruction to transmit a print job from the user.

In step S303, the CPU 103 receives an instruction to transmit a print job from the user on the print settings screen. As a result, the CPU 103 generates one or more pieces of print data for printing the images based on the one or more pieces of image data identified in step S301. In the present embodiment, an image corresponding to a single page is printed based on a single piece of print data. Then, the CPU 103 generates a print job including the one or more pieces of print data.

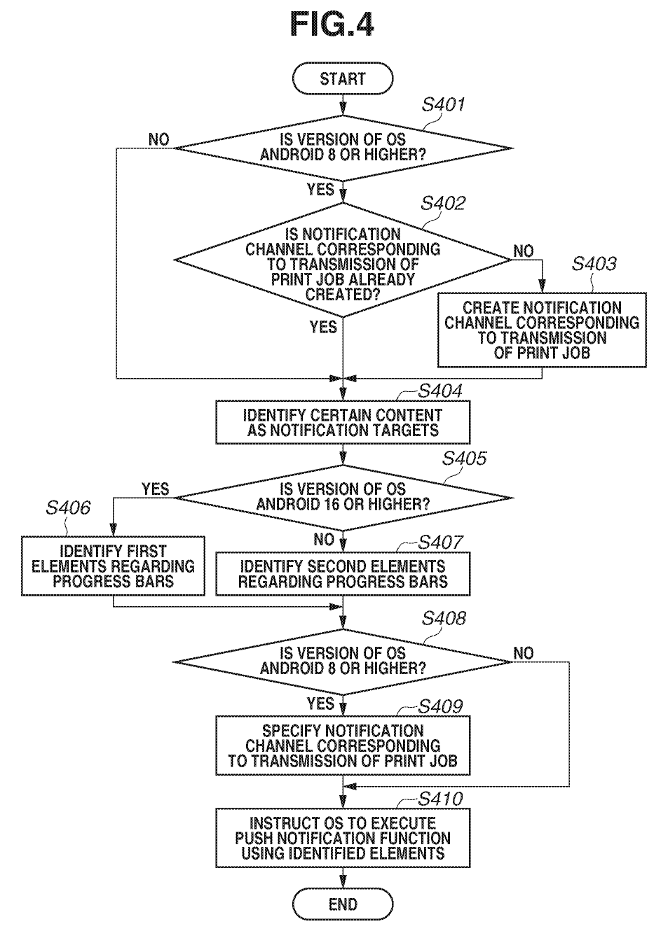

In step S304, the CPU 103 executes a process for notifying the user of job-related information using the push notification function. The details of this process will be described below with reference to FIG. 4.

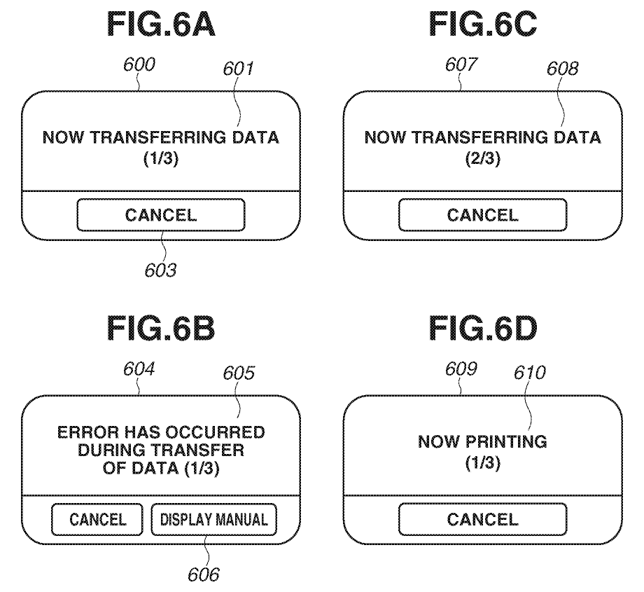

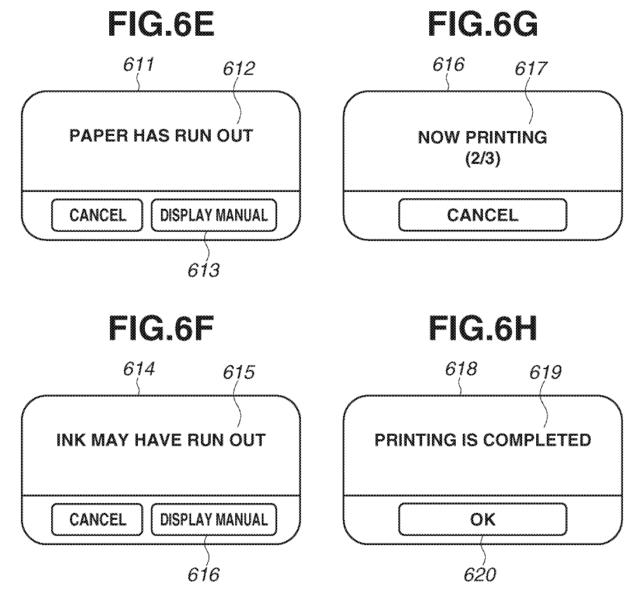

In step S305, the CPU 103 starts the process of notifying the user of the job-related information on the application screen displayed in the foreground by the predetermined app. FIG. 6A illustrates an example of the screen displayed in this case. An area 600 is the entirety of a notification area newly displayed by this process. An area 601 is text indicating that the print job is being transmitted. An area 603 is a button for cancelling the transmission of the print job. If the area 603 is operated, the CPU 103 stops (cancels) the transmission of the print job.

In step S306, the CPU 103 starts the transmission of the print job generated in step S303.

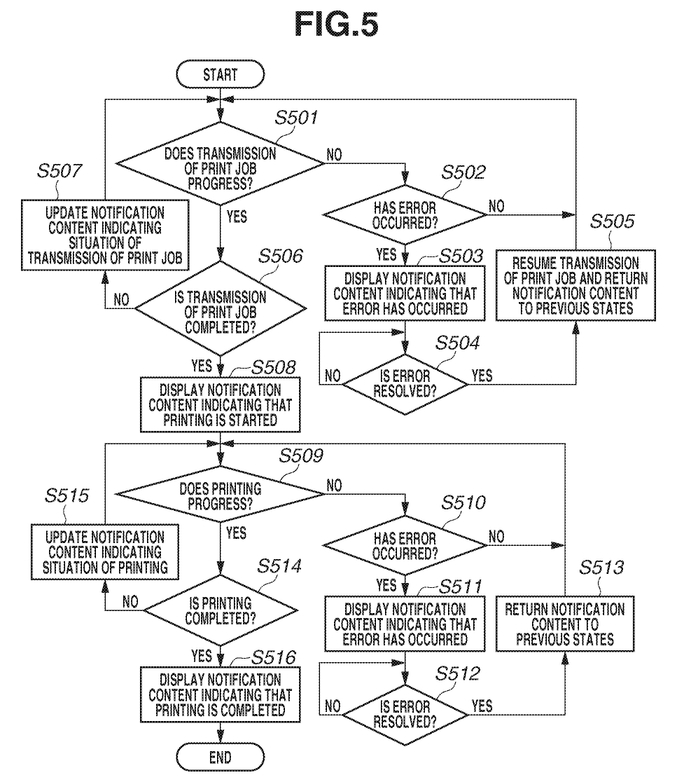

In step S307, the CPU 103 performs processing of updating the content of notifications provided via the push notification function and the notification content presented on the application screen. The details of this processing will be described below with reference to FIG. 5. Then, the CPU 103 ends the processing.

FIG. 4 is a flowchart illustrating the process for notifying the user of the job-related information using the push notification function that is executed by the predetermined app. This flowchart is achieved by the CPU 103 reading various programs stored in a memory such as the external storage device 106 or the like into the RAM 105 and executing the various programs. Specifically, this flowchart is achieved by executing the predetermined app. This flowchart corresponds to the process of step S304.

In step S401, the CPU 103 determines whether the version of the OS of the terminal apparatus 101 is a predetermined version or higher. In the present embodiment, the predetermined version is Android 8. This is because if an Android OS the version of which is Android 8 or higher is mounted on the terminal apparatus 101, a notification channel needs to be created so that the predetermined application can use the push notification function. If the determination is YES (YES in step S401), the processing proceeds to step S402. If the determination is NO (NO in step S401), the processing proceeds to step S404.

In step S402, the CPU 103 determines whether a notification channel corresponding to the transmission of the print job is already created. Specifically, the CPU 103 makes this determination by acquiring information regarding a notification channel already created as a notification channel used by the predetermined application from the OS. If the determination is YES (YES in step S402), the processing proceeds to step S404. If the determination is NO (NO in step S402), the processing proceeds to step S403.

In step S403, the CPU 103 instructs the OS to create the notification channel corresponding to the transmission of the print job. Specifically, the CPU 103 notifies the OS of the identifier (ID) of the notification channel as the creation target, the name of the notification channel as the creation target, and a numerical value indicating the degree of importance of the notification channel as the creation target. Consequently, the OS creates the notification channel corresponding to the transmission of the print job as a notification channel used by the predetermined app. If the notification channel corresponding to the transmission of the print job is created, a notification channel management screen displayed by an OS standard setting application provided as standard with the OS in the terminal apparatus 101 includes an area corresponding to the notification channel corresponding to the transmission of the print job. Then, the user operates this area and thereby can set whether to permit a push notification issued by specifying the notification channel corresponding to the transmission of the print job.

In step S404, the CPU 103 identifies, from among the notification target content (elements) provided via the push‑notification function, elements other than elements regarding progress bars. Specifically, for example, the elements other than the elements regarding the progress bars are the title of the notification, text displayed by the notification, a small icon displayed by the notification, a button displayed by the notification, and the like. In the present embodiment, the title of the notification is a title indicating that the print job is being transmitted. If a plurality of pieces of print data is included in the print job, the title may indicate that a portion of the print job corresponding to the first print data among the plurality of pieces of print data is being transmitted. Specifically, for example, a title having a character string such as "now transferring data (1/3)" is identified. In the present embodiment, the text displayed by the notification is text indicating that the print job is being transmitted. Specifically, for example, text having a character string such as "application is transferring data to printer." is identified. In the present embodiment, the small icon displayed by the notification is an application icon indicating the predetermined app. In the present embodiment, the button displayed by the notification is a cancel button, which is a button for cancelling the transmission of the print job. As the elements other than the elements regarding the progress bars, for example, a large icon displayed by the notification or the like may be identified in addition to the above elements. As the large icon displayed by the notification, specifically, for example, an icon corresponding to the first print data among the plurality of pieces of print data may be identified. A process executed in a case where a notification area displayed by the push notification is selected by the user may be identified. For example, as this process, a process of starting the predetermined application and causing the predetermined application to transition to the foreground may be identified. Consequently, even if the predetermined application is operating in the background, the notification area is operated, whereby it is possible to cause the predetermined application to transition to the foreground.

In step S405, the CPU 103 determines whether the version of the OS of the terminal apparatus 101 is a particular version or higher. In the present embodiment, the particular version is Android 16. This is because, starting with OS version Android 16, a predetermined customization function is provided for finely customizing, among the notification content provided via push notifications, a progress portion. Specifically, the predetermined customization function is a function termed progress-centric notifications. If the determination is YES (YES in step S405), the processing proceeds to step S406. If the determination is NO (NO in step S405), the processing proceeds to step S407.

In step S406, the CPU 103 identifies, from among the notification content targeted by the push notification, first elements regarding the progress bars. In the present embodiment, the first elements regarding the progress bars are elements termed ProgressStyle, which can be specified for an OS the version of which is Android OS16 or higher by the predetermined customization function. In this process, specifically, the CPU 103 identifies elements such as the color and the length of each of the progress bars that are display targets, the positions and the colors of marks placed between parts on the progress bar, and an image displayed as an icon that moves on the progress bars as ProgressStyle.

More specifically, the CPU 103 identifies elements regarding a progress bar corresponding to the transmission of the print job and a progress bar corresponding to the printing based on the print job as the progress bars that are the display targets. The CPU 103 also identifies the numbers and the positions of marks so that each of the progress bar corresponding to the transmission of the print job and the progress bar corresponding to the printing is divided into the number of parts equal to the number of pieces of print data included in the print job. That is, control is performed so that if N pieces of print data are included in the print job, N-1 marks are placed on the progress bar corresponding to the transmission of the print job. That is, control is performed so that if N pieces of print data are included in the print job, N-1 marks are placed on the progress bar corresponding to the printing. Consequently, control is performed so that marks are placed on each progress bar, whereby the progress bar is divided into a plurality of parts, and a single part corresponds to the transmission or the printing of a single piece of print data.

Control is performed so that the colors of the progress bar corresponding to the transmission of the print job and the progress bar corresponding to the printing based on the print job are different from each other. As the image displayed as the icon that moves on the progress bars, a first image indicating that the print job is being transmitted is specified.

The method for identifying the elements of ProgressStyle is not limited to the above form. For example, control may be performed so that marks placed between parts on each progress bar are not displayed. The colors of the progress bar corresponding to the transmission of the print job and the progress bar corresponding to the printing based on the print job may be the same as each other.

Whether to place marks on each progress bar may be controlled based on the number of pieces of print data included in the print job. Specifically, for example, control may be performed so that if the number of pieces of print data included in the print job is greater than or equal to a predetermined threshold (e.g., five), marks are not placed on the progress bar. Then, control may be performed so that if the number of pieces of print data included in the print job is less than the predetermined threshold, marks are placed on the progress bar. This is because if the number of pieces of print data included in the print job is great, and the progress bar is divided into many parts by marks, the visibility of the push notification may deteriorate.

The content of the first image may be any image. For example, the first image may be an image represented by the first print data included in the print job.

In a case where each progress bar is divided into a plurality of parts by placing marks on the progress bar, control may be performed so that the length of a first part corresponding to the transmission of first print data and the length of a second part corresponding to the transmission of second print data are the same as each other or different from each other. Specifically, for example, control may be performed so that based on the ratio between the magnitude of the data size of the first print data and the magnitude of the data size of the second print data, the lengths of the respective parts are different from each other. In this form, for example, control is performed so that the larger the data size of the print data corresponding to the part is, the longer the part is. Similarly, control may be performed so that the length of the first part corresponding to printing based on the first print data and the length of the second part corresponding to printing based on the second print data are the same as each other or different from each other. Specifically, for example, control may be performed so that based on the ratio between the magnitude of the data size of the first print data and the magnitude of the data size of the second print data, the lengths of the respective parts are different from each other. In this form, for example, control is performed so that the larger the data size of the print data corresponding to the part is, the longer the part is.

In step S407, the CPU 103 identifies, from among the content to be notified via the push‑notification function, second elements regarding the progress bars. In the present embodiment, the second elements regarding the progress bars are elements termed setProgress, which are specified without using the predetermined customization function, and are elements that can be specified by an Android OS the version of which is Android OS4 or later. In this process, specifically, the CPU 103 identifies an element such as the display form of the progress bars as setProgress. Examples of the display form of the progress bars include a display form termed progress in which an icon is displayed on the progress bars and the icon is moved based on the progress of processing, and a display form termed indeterminate progress in which an icon that moves on the progress bars is not displayed and the progress bars that automatically change their designs are displayed. In the present embodiment, the display form termed indeterminate progress is identified.

In a form in which the predetermined customization function is not used, the predetermined application cannot display a plurality of progress bars, control the color of a progress bar to be any color, place marks, or control an image displayed as an icon to be any image in the push notification. Thus, in the identification of the elements of setProgress, unlike the identification of the elements of ProgressStyle, elements such as the color and the length of each of the progress bars that are display targets, the positions and the colors of marks placed between parts on the progress bar, and an image displayed as an icon that moves on the progress bars are not identified.

In step S408, the CPU 103 determines whether the version of the OS of the terminal apparatus 101 is the predetermined version or higher. This process is similar to that of step S401. If the determination is YES (YES in step S408), the processing proceeds to step S409. If the determination is NO (NO in step S408), the processing proceeds to step S410.

In step S409, the CPU 103 specifies the notification channel corresponding to the transmission of the print job for the OS as a notification channel used for the push notification.

In step S410, the CPU 103 instructs the OS to execute the push notification function using the elements identified in step S404 and step S406 or S407. Consequently, the OS displays a push notification area in an upper portion of a screen included in the terminal apparatus 101. Then, the processing ends. In the present embodiment, control is performed so that if an area other than a button in the notification area displayed by the push notification is selected by the user, the process of causing the predetermined application to transition to the foreground is executed.

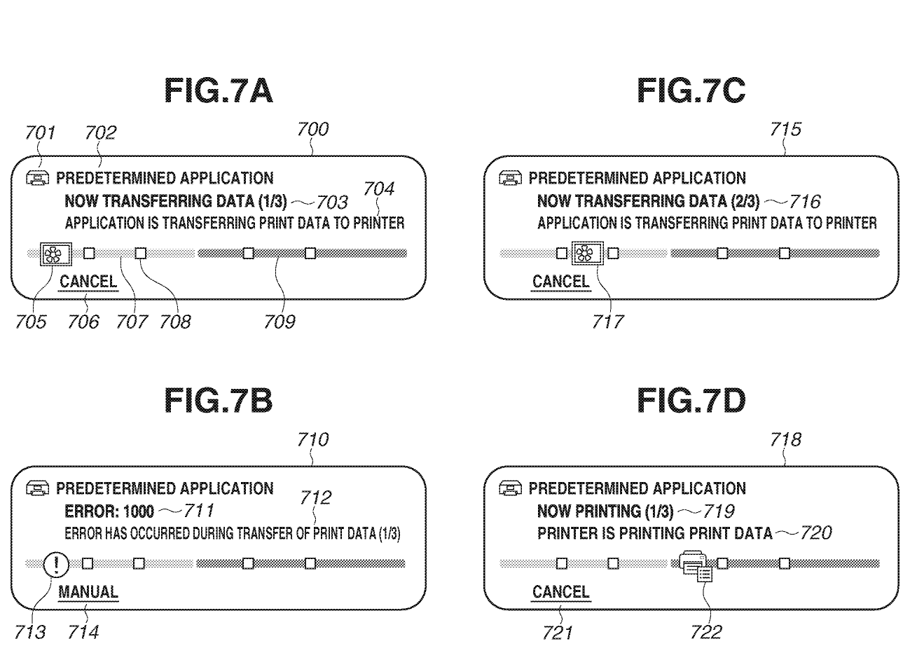

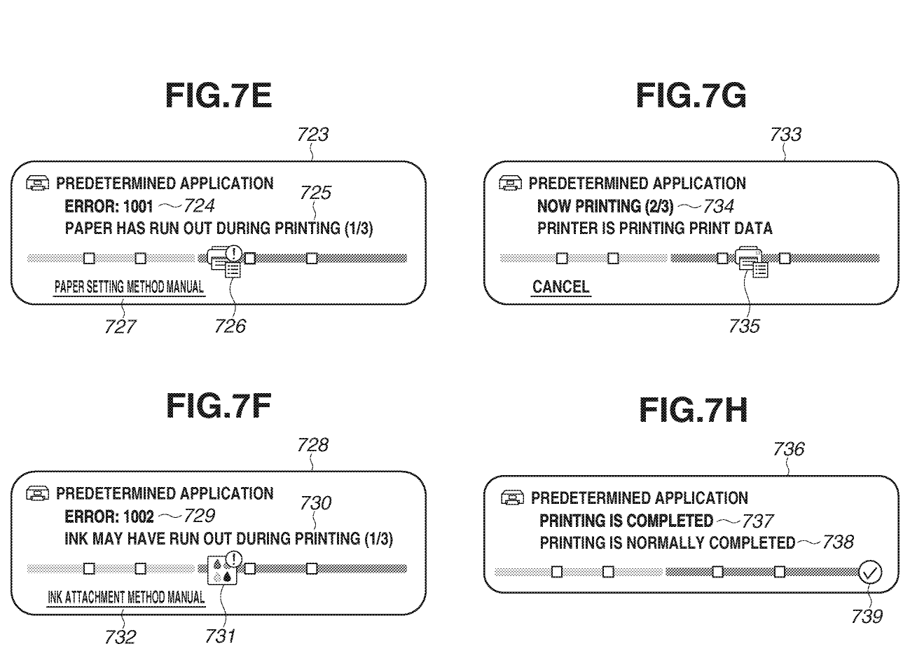

FIG. 7A illustrates an example of the push notification area displayed in step S410 in a case where the version of the OS of the terminal apparatus 101 is the particular version or higher. A push notification area 700 is the entirety of the push notification area displayed using the elements identified in steps S404 and S406.

An area 701 is an area displayed using the element identified as the small icon. An area 702 is an area that displays the name of the predetermined application that is the application that has instructed the OS to execute the push notification function. An area 703 is an area displayed using the element identified as the title of the notification. An area 704 is an area displayed using the element identified as the text displayed by the notification. An area 705 is an area displayed using the element identified as the image displayed as the icon that moves on the progress bars. An area 706 is an area displayed using the element identified as the button displayed by the notification. An area 707 is an area displayed using the element identified as the color and the length of each of the progress bars that are the display targets, and is the progress bar corresponding to the transmission of the print job. In this push notification area, the progress bar corresponding to the transmission of the print job is separated into three parts by marks. An area 708 is an area displayed using the element identified as the positions and the colors of marks placed between parts on the progress bar. In the present embodiment, marks are placed between a plurality of parts on the progress bar corresponding to the transmission of the print job and between a plurality of parts on the progress bar corresponding to the printing based on the print job. An area 709 is an area displayed using the element identified as the color and the length of each of the progress bars that are the display targets, and is the progress bar corresponding to the printing based on the print job.

In this push notification area, the progress bar corresponding to the printing based on the print job is separated into three parts by marks. If the cancel button is operated, the OS notifies the predetermined application that the cancel button is pressed. Then, if the predetermined application is transmitting the print job, the predetermined application stops (cancels) the transmission of the print job. If the communication apparatus 151 is executing the printing based on the print job, the predetermined application transmits an instruction to stop the printing based on the print job to the communication apparatus 151 and stops the printing.

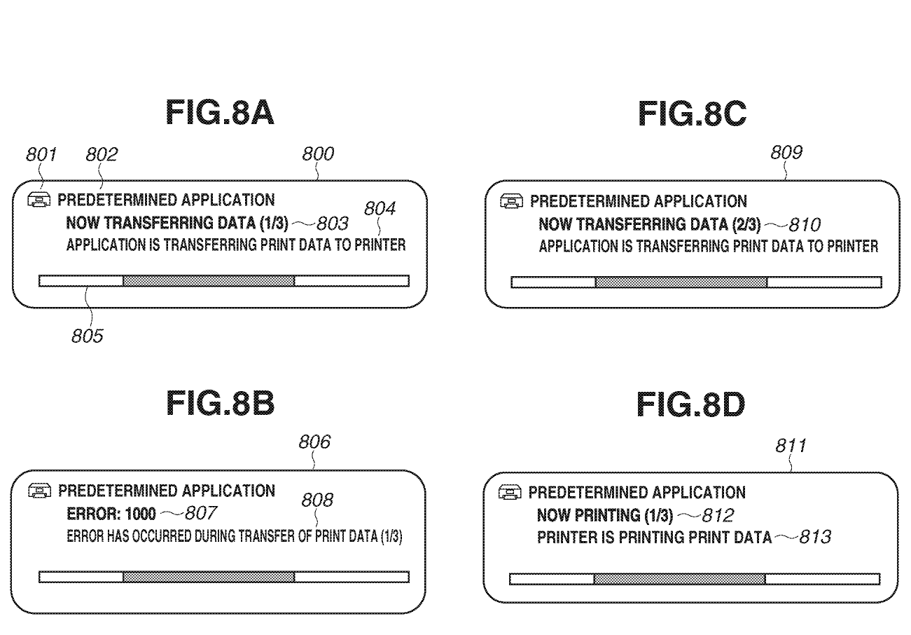

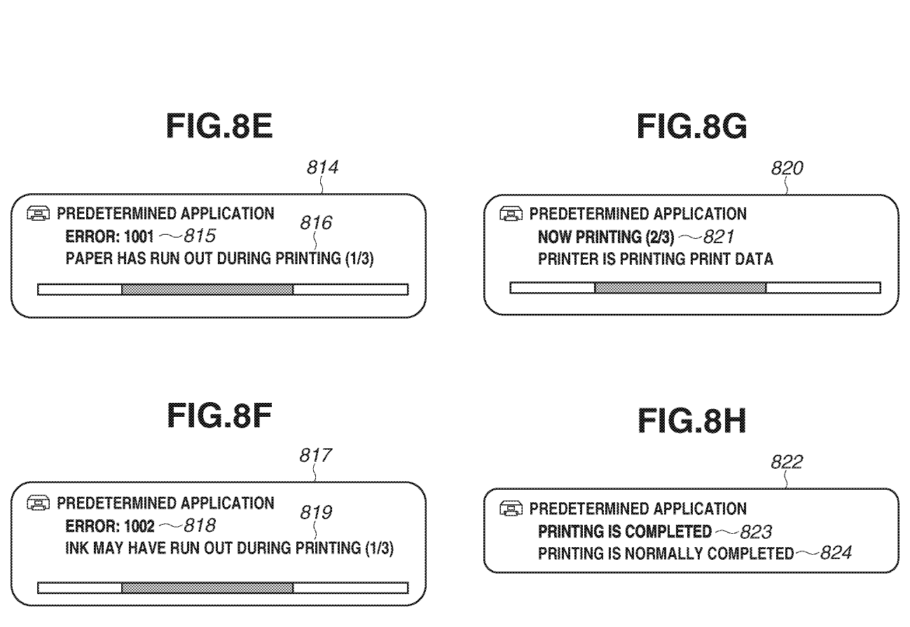

FIG. 8A illustrates an example of the push notification area displayed in step S410 in a case where the version of the OS of the terminal apparatus 101 is lower than the particular version. A push notification area 800 is the entirety of the push notification area displayed using the elements identified in steps S404 and S407.

Areas 801 to 804 are similar to the areas 701 to 704, respectively. An area 805 is an area displayed using the element identified as the display form of the progress bars and is progress bars in the display form termed indeterminate progress.

FIG. 5 is a flowchart illustrating the process for updating notification content that is executed by the predetermined app. This flowchart is achieved by the CPU 103 reading various programs stored in a memory such as the external storage device 106 or the like into the RAM 105 and executing the various programs. Specifically, this flowchart is achieved by executing the predetermined app. This flowchart corresponds to the process of step S307.

In step S501, the CPU 103 determines whether the transmission of the print job progresses. Specifically, the CPU 103 determines whether the transmission of a single piece of print data the transmission of which has not yet been completed among the pieces of print data included in the print job is completed. If the determination is YES (YES in step S501), the processing proceeds to step S506. If the determination is NO (NO in step S501), the processing proceeds to step S502.

In step S502, the CPU 103 determines whether an error has occurred in the transmission of the print job. Specifically, for example, the error in the transmission of the print job can occur in a case where the communication between the terminal apparatus 101 and the communication apparatus 151 becomes impossible for some reason or the like. If the determination is YES (YES in step S502), the processing proceeds to step S503. If the determination is NO (NO in step S502), the processing returns to step S501.

In step S503, the CPU 103 updates the notification area, thereby displaying the notification content indicating that an error has occurred as an error notification. Specifically, the CPU 103 identifies a character string indicating an error code corresponding to the error that has occurred as the title of the notification. The character string identified in this case may be the name of the error that has occurred or the like. The CPU 103 also identifies text indicating that an error in the transmission of the print job has occurred as the text displayed by the notification. The text identified in this case may include text indicating the sequential number of print data transmitted among the pieces of print data included in the print job while the error has occurred. For example, if three pieces of print data are included in the print job, and an error has occurred during the transmission of the first print data, text "error has occurred during transfer of print data (1/3)." is identified. Then, if the version of the OS of the terminal apparatus 101 is the particular version or higher, the CPU 103 further also newly identifies the elements of ProgressStyle. Specifically, the CPU 103 identifies an image indicating the error in the transmission of the print job as the image displayed as the icon that moves on the progress bars. The CPU 103 also identifies a button for displaying in a web browser a web manual describing a method for resolving the error that has occurred as the button displayed by the notification. Then, the CPU 103 instructs the OS to update the push notification area using the identified elements. If the predetermined application is operating in the foreground, the CPU 103 also updates the notification area displayed on the application screen.

FIG. 6B illustrates an example of the notification area displayed on the application screen by this process. In FIG. 6B, unspecified portions are similar to FIG. 6A. An area 604 is the entirety of the notification area displayed by this process. An area 605 is text indicating that an error in the transmission of the print job has occurred. An area 606 is a button for displaying in the web browser a web manual describing a method for resolving the error in the transmission of the print job.

FIG. 7B illustrates an example of the push notification area displayed by this process in a case where the version of the OS of the terminal apparatus 101 is the particular version or higher. In FIG. 7B, unspecified portions are similar to FIG. 7A. A push notification area 710 is the entirety of the push notification area displayed by this process. An area 711 is an area displayed using the element identified as the title of the notification. An area 712 is an area displayed using the element identified as the text displayed by the notification. An area 713 is an area displayed using the element identified as the image displayed as the icon that moves on the progress bars. An area 714 is an area displayed using the element identified as the button displayed by the notification.

FIG. 8B illustrates an example of the push notification area displayed by this process in a case where the version of the OS of the terminal apparatus 101 is lower than the particular version. In FIG. 8B, unspecified portions are similar to FIG. 8A. A push notification area 806 is the entirety of the push notification area displayed by this process. Areas 807 and 808 are similar to the areas 711 and 712, respectively. Control may be performed so that in the push notification area 806 displayed when an error occurs, the progress bars are not displayed.

In step S504, the CPU 103 determines whether the error is resolved. If the determination is YES (YES in step S504), the processing proceeds to step S505. If the determination is NO (NO in step S504), this determination is repeated.

In step S505, the CPU 103 performs a process of resuming the transmission of the print job and returning the notification content in the push notification area and the notification area on the application screen to the states before the display content is updated in step S503. Then, the processing returns to step S501.

If the determination is YES in step S501, then in step S506, the CPU 103 determines whether the transmission of the print job is completed. In other words, this determination is the determination of whether the transmission of all the pieces of print data included in the print job is completed. If the determination is YES (YES in step S506), the processing proceeds to step S508. If the determination is NO (NO in step S506), the processing proceeds to step S507.

In step S507, the CPU 103 updates the notification area, thereby displaying the notification content indicating the print job is being transmitted and indicating the progress of the transmission of the print job. Specifically, the CPU 103 identifies a title indicating that the print job is being transmitted and indicating the progress of the transmission of the print job as the title of the notification. The title identified in this case may include a title indicating the sequential number of print data that is being transmitted among the pieces of print data included in the print job. For example, if three pieces of print data are included in the print job, and the second print data is being transmitted due to the completion of the transmission of the first print data, a title such as "now transferring data (2/3)" is identified. The CPU 103 also identifies text indicating that the print job is being transmitted and indicating the progress of the transmission of the print job as the text displayed by the notification. The text identified in this case may include text indicating the sequential number of print data that is being transmitted among the pieces of print data included in the print job. Specifically, for example, a title such as "application is transferring print data to printer" is identified. Then, if the version of the OS of the terminal apparatus 101 is the particular version or higher, the CPU 103 further also newly identifies the elements of ProgressStyle. Specifically, the CPU 103 identifies the position of the icon so that the icon moves onto the next part on the progress bars. Then, the CPU 103 instructs the OS to update the push notification area using the identified elements. If the predetermined application is operating in the foreground, the CPU 103 also updates the notification area displayed on the application screen. Then, the processing returns to step S501.

FIG. 6C illustrates an example of the notification area displayed on the application screen by this process. In FIG. 6C, unspecified portions are similar to FIG. 6A. An area 607 is the entirety of the notification area displayed by this process. An area 608 is text indicating that the second print data among the three pieces of print data included in the print job is being transmitted.

FIG. 7C illustrates an example of the push notification area displayed by this process in a case where the version of the OS of the terminal apparatus 101 is the particular version or higher. In FIG. 7C, unspecified portions are similar to FIG. 7A. A push notification area 715 is the entirety of the push notification area displayed by this process. An area 716 is an area displayed using the element identified as the title of the notification. An area 717 is the icon that moves on the progress bars, and is an area displayed based on the identified position. In FIG. 7A, the icon is located on a first part on the progress bar corresponding to the transmission of the print job, whereas in FIG. 7C, the icon is controlled to be located on a second part on the progress bar corresponding to the transmission of the print job.

FIG. 8C illustrates an example of the push notification area displayed by this process in a case where the version of the OS of the terminal apparatus 101 is lower than the particular version. A push notification area 809 is the entirety of the push notification area displayed by this process. An area 810 is similar to the area 716.

If the determination is YES in step S506, then in step S508, the CPU 103 updates the notification area, thereby displaying the notification content indicating that the printing based on the print job is started. Specifically, the CPU 103 identifies a title indicating that the printing based on the print job is being executed as the title of the notification. The title identified in this case may include a title indicating the sequential number of print data based on which printing is being executed among the pieces of print data included in the print job. For example, if three pieces of print data are included in the print job, and printing based on the first print data is started, a title such as "now printing (1/3)" is identified. The CPU 103 also identifies text indicating that the communication apparatus 151 is executing the printing as the text displayed by the notification. Specifically, for example, in this case, text such as "printer is printing print data" is identified. A button for cancelling the execution of the printing is also identified as the button displayed by the notification. Then, if the version of the OS of the terminal apparatus 101 is the particular version or higher, the CPU 103 further also newly identifies the elements of ProgressStyle. Specifically, the CPU 103 identifies the position of the icon so that the icon moves onto the next part on the progress bars and onto the progress bar corresponding to the printing based on the print job. Then, the CPU 103 instructs the OS to update the push notification area using the identified elements. If the predetermined application is operating in the foreground, the CPU 103 also updates the notification area displayed on the application screen. Then, the processing proceeds to step S509. Before the process of step S508 is executed, the CPU 103 may display a notification area indicating that the transmission of print data is completed, using a push notification or a notification on the application screen.

FIG. 6D illustrates an example of the notification area displayed on the application screen by this process. In FIG. 6D, unspecified portions are similar to FIG. 6A. An area 609 is the entirety of the notification area displayed by this process. An area 610 is text indicating that printing based on the first print data among the three pieces of print data included in the print job is being executed.

FIG. 7D illustrates an example of the push notification area displayed by this process in a case where the version of the OS of the terminal apparatus 101 is the particular version or higher. In FIG. 7D, unspecified portions are similar to FIG. 7A. A push notification area 718 is the entirety of the push notification area displayed by this process. An area 719 is an area displayed using the element identified as the title of the notification. An area 720 is an area displayed using the element identified as the text displayed by the notification. An area 721 is an area displayed using the element identified as the button displayed by the notification. If the area 721 is operated, the CPU 103 transmits an instruction to stop the printing based on the print job to the communication apparatus 151 and stops the printing. An area 722 is the icon that moves on the progress bars, and is an area displayed based on the identified position. In FIG. 7D, the icon is controlled to be located on the progress bar corresponding to the printing based on the print job.

FIG. 8D illustrates an example of the push notification area displayed by this process in a case where the version of the OS of the terminal apparatus 101 is lower than the particular version. A push notification area 811 is the entirety of the push notification area displayed by this process. Areas 812 and 813 are similar to the areas 719 and 720, respectively.

In step S509, the CPU 103 determines whether the printing that is being executed by the communication apparatus 151 progresses. Specifically, the CPU 103 determines whether printing based on a single piece of print data the printing of which has not yet been completed among the pieces of print data included in the print job is completed. The CPU 103 appropriately receives information regarding the status of the printing that is being executed by the communication apparatus 151 from the communication apparatus 151. The CPU 103 makes this determination based on this information. If the determination is YES (YES in step S509), the processing proceeds to step S514. If the determination is NO (NO in step S509), the processing proceeds to step S510.

In step S510, the CPU 103 determines whether an error has occurred in the execution of the printing. Specifically, for example, the error regarding the printing is an out-of-paper error that is an error in which sheets set in the communication apparatus 151 run out, an ink deficiency error that is an error in which a recording material (ink or toner) included in the communication apparatus 151 is deficient, or an out-of-ink error. For example, the error regarding the printing is a paper jam error that is an error in which a paper jam occurs in the communication apparatus 151. The CPU 103 appropriately receives information regarding the status of the printing that is being executed by the communication apparatus 151 from the communication apparatus 151. The CPU 103 makes this determination based on this information. If the determination is YES (YES in step S510), the processing proceeds to step S511. If the determination is NO (NO in step S510), the processing returns to step S509.

In step S511, the CPU 103 updates the notification area, thereby displaying the notification content indicating that an error has occurred. Specifically, the CPU 103 identifies a character string indicating an error code corresponding to the error that has occurred as the title of the notification. The error code differs depending on the error that has occurred. The character string identified in this case may be the name of the error that has occurred or the like. The CPU 103 also identifies text indicating that an error regarding the printing has occurred as the text displayed by the notification. The text identified in this case may include text indicating which error has occurred and the sequential number of print data printed among the pieces of print data included in the print job while the error has occurred. If an out-of-paper error has occurred, specifically, for example, text such as "paper has run out during printing (1/3)." is identified. That is, for example, text indicating that an out-of-paper error has occurred while the first print data among the pieces of print data included in the print job is being printed is identified. If an out-of-ink error has occurred, specifically, for example, text such as "ink may have run out during printing (1/3)." is identified.

Then, if the version of the OS of the terminal apparatus 101 is the particular version or higher, the CPU 103 further also newly identifies the elements of ProgressStyle. Specifically, the CPU 103 identifies an image indicating the error regarding the printing as the image displayed as the icon that moves on the progress bars. At this time, a different icon may be identified according to details of an error regarding the printing. The CPU 103 also identifies a button for displaying in the web browser a web manual describing a method for resolving the error that has occurred as the button displayed by the notification. At this time, the button may be identified so that a different web manual is displayed according to the details of the error regarding the printing. Then, the CPU 103 instructs the OS to update the push notification area using the identified elements. If the predetermined application is operating in the foreground, the CPU 103 also updates the notification area displayed on the application screen.

FIG. 6E illustrates an example of the notification area displayed on the application screen by this process in a case where an out-of-paper error has occurred. In FIG. 6E, unspecified portions are similar to FIG. 6A.

An area 611 is the entirety of the notification area displayed by this process. An area 612 is text indicating that an out-of-paper error has occurred. An area 613 is a button for displaying in the web browser a web manual describing a method for resolving the out-of-paper error.

FIG. 6F illustrates an example of the notification area displayed on the application screen by this process in a case where an out-of-ink error has occurred. In FIG. 6F, unspecified portions are similar to FIG. 6A. An area 614 is the entirety of the notification area displayed by this process. An area 615 is text indicating that an out-of-ink error has occurred. An area 616 is a button for displaying in the web browser a web manual describing a method for resolving the out-of-ink error.

FIG. 7E illustrates an example of the push notification area displayed by this process in a case where an out-of-paper error has occurred and the version of the OS of the terminal apparatus 101 is the particular version or higher. In FIG. 7E, unspecified portions are similar to FIG. 7A. A push notification area 723 is the entirety of the push notification area displayed by this process. An area 724 is an area displayed using the element identified as the title of the notification. An area 725 is an area displayed using the element identified as the text displayed by the notification. An area 726 is an area displayed using the element identified as the image displayed as the icon that moves on the progress bars. An area 727 is an area displayed using the element identified as the button displayed by the notification.

FIG. 7F illustrates an example of the push notification area displayed by this process in a case where an out-of-ink error has occurred and the version of the OS of the terminal apparatus 101 is the particular version or higher. In FIG. 7F, unspecified portions are similar to FIG. 7A. A push notification area 728 is the entirety of the push notification area displayed by this process. An area 729 is an area displayed using the element identified as the title of the notification. An area 730 is an area displayed using the element identified as the text displayed by the notification. An area 731 is an area displayed using the element identified as the image displayed as the icon that moves on the progress bars. In the present embodiment, different icons are displayed between when an out-of-paper error occurs and when an out-of-ink error occurs. An area 732 is an area displayed using the element identified as the button displayed by the notification. In the present embodiment, control is performed so that as a screen displayed in a case where the button is selected, different web manuals are displayed between when an out-of-paper error occurs and when an out-of-ink error occurs.

FIG. 8E illustrates an example of the push notification area displayed by this process in a case where an out-of-paper error has occurred and the version of the OS of the terminal apparatus 101 is lower than the particular version. In FIG. 8E, unspecified portions are similar to FIG. 8A. A push notification area 814 is the entirety of the push notification area displayed by this process. Areas 815 and 816 are similar to the areas 724 and 725, respectively. Control may be performed so that in the push notification area 814 displayed when an error occurs, the progress bars are not displayed.

FIG. 8F illustrates an example of the push notification area displayed by this process in a case where an out-of-ink error has occurred and the version of the OS of the terminal apparatus 101 is lower than the particular version. In FIG. 8F, unspecified portions are similar to FIG. 8A. A push notification area 817 is the entirety of the push notification area displayed by this process. Areas 818 and 819 are similar to the areas 729 and 730, respectively. Control may be performed so that in the push notification area 817 displayed when an error occurs, the progress bars are not displayed.

In step S512, the CPU 103 determines whether the error is resolved. The CPU 103 appropriately receives information regarding the status of the printing that is being executed by the communication apparatus 151 from the communication apparatus 151. The CPU 103 makes this determination based on this information. If the determination is YES (YES in step S512), the processing proceeds to step S513. If the determination is NO (NO in step S512), this determination is repeated.

In step S513, the CPU 103 performs a process of returning the notification content in the push notification area and the notification area on the application screen to the states before the display content is updated in step S511. Then, the processing returns to step S509.

If the determination is YES in step S509, then in step S514, the CPU 103 determines whether the printing is completed in the communication apparatus 151. In other words, this determination is the determination of whether the printing based on all the pieces of print data included in the print job is completed. If the determination is YES (YES in step S514), the processing proceeds to step S516. If the determination is NO (NO in step S514), the processing proceeds to step S515.

In step S515, the CPU 103 updates the notification area, thereby displaying the notification content indicating that the printing is being performed and indicating the progress of the printing. Specifically, the CPU 103 identifies a title indicating that the printing is being performed and indicating the progress of the printing as the title of the notification. The title identified in this case may include a title indicating the sequential number of print data based on which printing is being executed among the pieces of print data included in the print job. Specifically, in this case, a title such as "now printing (2/3)" is identified. The CPU 103 also identifies text indicating that printing is being performed and indicating the progress of the printing as the text displayed by the notification. The text identified in this case may include text indicating the sequential number of print data based on which printing is being executed among the pieces of print data included in the print job. Specifically, in this case, a title such as "printer is printing print data" is identified. Then, if the version of the OS of the terminal apparatus 101 is the particular version or higher, the CPU 103 further also newly identifies the elements of ProgressStyle. Specifically, the CPU 103 identifies the position of the icon so that the icon moves onto the next part on the progress bars. Then, the CPU 103 instructs the OS to update the push notification area using the identified elements. If the predetermined application is operating in the foreground, the CPU 103 also updates the notification area displayed on the application screen. Then, the processing returns to step S509.

FIG. 6G illustrates an example of the notification area displayed on the application screen by this process. In FIG. 6G, unspecified portions are similar to FIG. 6A. An area 616 is the entirety of the notification area displayed by this process. An area 617 is text indicating that printing based on the second print data among the plurality of pieces of print data included in the print job is being executed.

FIG. 7G illustrates an example of the push notification area displayed by this process in a case where the version of the OS of the terminal apparatus 101 is the particular version or higher. In FIG. 7G, unspecified portions are similar to FIG. 7A. A push notification area 733 is the entirety of the push notification area displayed by this process. An area 734 is an area displayed using the element identified as the title of the notification. An area 735 is the icon that moves on the progress bars, and is an area displayed based on the identified position. In FIG. 7C, the icon is located on a first part on the progress bar corresponding to the printing, whereas in FIG. 7G, the icon is controlled to be located on a second part of the progress bar corresponding to the printing.

FIG. 8G illustrates an example of the push notification area displayed by this process in a case where the version of the OS of the terminal apparatus 101 is lower than the particular version. A push notification area 820 is the entirety of the push notification area displayed by this process. An area 821 is similar to the area 734.

If the determination is YES in step S514, then in step S516, the CPU 103 updates the notification area, thereby displaying the notification content indicating that the printing based on the print job is completed. Specifically, the CPU 103 identifies a title indicating that the printing based on the print job is completed as the title of the notification. Specifically, for example, in this case, a title such as "printing is completed" is identified. The CPU 103 also identifies text indicating that the printing based on the print job is completed as the text displayed by the notification. Specifically, for example, in this case, text such as "printing is normally completed" is identified. Then, if the version of the OS of the terminal apparatus 101 is the particular version or higher, the CPU 103 further also newly identifies the elements of ProgressStyle. Specifically, the CPU 103 identifies an image indicating that the printing is completed as the image displayed as the icon that moves on the progress bars. This image is an image different from the image indicating that the print job is being transmitted, the image indicating that the printing is being performed, and the image indicating that an error has occurred. Then, the CPU 103 instructs the OS to update the push notification area using the identified elements. If the predetermined application is operating in the foreground, the CPU 103 also updates the notification area displayed on the application screen. Then, the processing of this flowchart ends.

FIG. 6H illustrates an example of the notification area displayed on the application screen by this process. In FIG. 6H, unspecified portions are similar to FIG. 6A. An area 618 is the entirety of the notification area displayed by this process. An area 619 is text indicating that the printing based on the print job is completed. An area 620 is a button for closing the notification area displayed on the application screen.

FIG. 7H illustrates an example of the push notification area displayed by this process in a case where the version of the OS of the terminal apparatus 101 is the particular version or higher. In FIG. 7H, unspecified portions are similar to FIG. 7A. A push notification area 736 is the entirety of the push notification area displayed by this process. An area 737 is an area displayed using the element identified as the title of the notification. An area 738 is an area displayed using the element identified as the text displayed by the notification. An area 739 is the icon that moves on the progress bars, and is an area displayed based on the identified position. In FIG. 7H, the icon is controlled to be located at the end of the progress bars.

FIG. 8H illustrates an example of the push notification area displayed by this process in a case where the version of the OS of the terminal apparatus 101 is lower than the particular version. A push notification area 822 is the entirety of the push notification area displayed by this process. Areas 823 and 824 are similar to the areas 737 and 738, respectively. In FIG. 8H, control is performed so that the progress bars are not displayed.

With this form, it is possible to improve the visibility of a push notification area and cause a user to recognize the situation of the transmission of a print job, the situation of printing based on the print job, and the occurrence situation of an error in detail.

### Other Embodiments

Although in the above form, both the title and the text are included in each of the push notification areas, control may be performed so that only either one of the title and the text is included in the push notification area. Specifically, for example, a form may be employed in which a sentence indicating that a print job is being transmitted or that printing is being executed is displayed not by both but by one of the title and the text.

Although in the above form, the push notification areas displayed in a case where the version of the OS of the terminal apparatus 101 is lower than the particular version include a push notification area where the progress bars are displayed, the present disclosure is not limited to this form. The progress bars may not be displayed in any of the push notification areas displayed in a case where the version of the OS of the terminal apparatus 101 is lower than the particular version.

Although in the above form, each of the push notification areas displayed in a case where the version of the OS of the terminal apparatus 101 is lower than the particular version does not include a cancel button or a button for displaying a web manual, the present disclosure is not limited to this form. The push notification area may include the above buttons similarly to the push notification areas displayed in a case where the version of the OS of the terminal apparatus 101 is the particular version or higher.

Although in the above form, the push notification areas displayed in a case where the version of the OS of the terminal apparatus 101 is lower than the particular version include a push notification area where progress bars in the display form termed indeterminate progress are displayed, the present disclosure is not limited to this form. A progress bar in a normal display form may be displayed. The predetermined application can control the position of an icon displayed on the progress bar in the normal display form. The predetermined app, however, cannot display a plurality of progress bars, or control the color and the length of the progress bar or an image of the icon.

Control may be performed so that the color of the progress bars displayed in each of the push notification areas displayed in a case where an error has occurred and the color of the progress bars displayed in each of the push notification areas displayed in a case where an error has not occurred are different from each other. Specifically, for example, control may be performed so that the color of the progress bar on which the icon is located in FIG. 7A and the color of the progress bar on which the icon is located in FIG. 7B are different from each other.

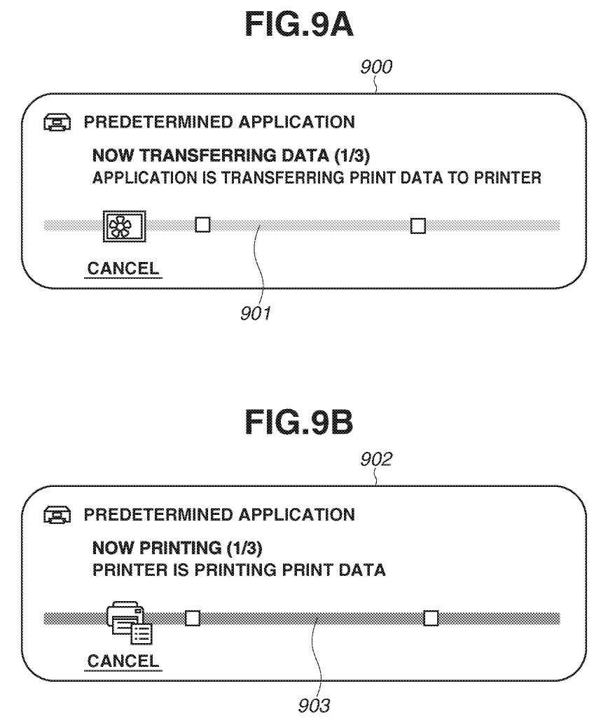

In the above description, a form has been described in which the progress bar corresponding to the transmission of the print job and the progress bar corresponding to the printing based on the print job are included together (in parallel) in a single push notification area. The present disclosure, however, is not limited to this form. A form may be employed in which the two progress bars are not included in parallel in a single push notification area, but are included in separate push notification areas. In this form, specifically, for example, control is performed so that only the progress bar corresponding to the transmission of the print job between the two progress bars is included in a single push notification area until the transmission of the print job is completed. Control is performed so that after the transmission of the print job is completed and until the printing is completed, only the progress bar corresponding to the printing between the two progress bars is included in a single push notification area. FIGS. 9A and 9B illustrate examples of push notification areas displayed by push notifications in a case where the version of the OS of the terminal apparatus 101 is the particular version or higher in this form. FIG. 9A is an example of a push notification area displayed during the transmission of the print job. In FIG. 9A, unspecified portions are similar to FIG. 7A.

A push notification area 900 is the entirety of the push notification area displayed by this process. An area 901 is an area displayed using the element identified as the color and the length of each of the progress bars that are the display targets, and is the progress bar corresponding to the transmission of the print job. In FIG. 9A, control is performed so that the progress bar corresponding to the printing is not displayed. FIG. 9B is an example of a push notification area displayed during the execution of the printing. In FIG. 9B, unspecified portions are similar to FIG. 7D. A push notification area 902 is the entirety of the push notification area displayed by this process. An area 903 is an area displayed using the element identified as the color and the length of each of the progress bars that are the display targets, and is the progress bar corresponding to the printing. In FIG. 9B, control is performed so that the progress bar corresponding to the transmission of the print job is not displayed. Control is performed so that the color of the progress bar and the image used as the icon that are displayed in FIG. 9A are different from the color of the progress bar and the image used as the icon that are displayed in FIG. 9B.

In the above description, a form has been described in which in a case where a plurality of pieces of print data is included in a print job, printing is started after the entirety of the print job including the plurality of pieces of print data is transmitted. The present disclosure, however, is not limited to this form. For example, a particular form may be employed in which in a case where a plurality of pieces of print data is included in a print job, and if a portion of the print job corresponding to first print data is transmitted, printing based on the first print data is started, and if the printing is completed, the transmission of a portion of the print job corresponding to second print data is started.

Then, in the particular form, a progress bar corresponding to the transmission of the portion of the print job corresponding to the first print data and a progress bar corresponding to the printing based on the first print data may not be divided. That is, a first progress bar corresponding to both the transmission of the portion of the print job corresponding to the first print data and the printing based on the first print data may be created. Then, separately from the first progress bar, a second progress bar corresponding to both the transmission of the portion of the print job corresponding to the second print data and the printing based on the second print data may be created. Control may be performed so that in the first progress bar, a mark is placed between a portion corresponding to the transmission of the portion of the print job corresponding to the first print data and a portion corresponding to the printing based on the first print data. Similarly, control may be performed so that in the second progress bar, a mark is placed between a portion corresponding to the transmission of the portion of the print job corresponding to the second print data and a portion corresponding to the printing based on the second print data.

In the particular form, a single progress bar corresponding to both the entirety of the transmission of the print job and the entirety of the printing may be created. Then, control may be performed so that marks are placed between portions corresponding to the pieces of print data. Specifically, for example, control may be performed so that a mark is placed between a portion corresponding to both the transmission of the portion of the print job corresponding to the first print data and the printing based on the first print data and a portion corresponding to both the transmission of the portion of the print job corresponding to the second print data and the printing based on the second print data.

Although in the above form, a form has been described in which the progress bar corresponding to the transmission of the print job and the progress bar corresponding to the printing are displayed, a progress bar corresponding to processing other than the transmission of the print job and the printing may be displayed. For example, as described above, if an instruction to transmit a print job is received, the predetermined application executes a process of generating a print job. Thus, a progress bar corresponding to the process of generating a print job may be displayed in a push notification area.

After the printing is completed, the predetermined application may execute a process of deleting the print job the transmission of which is completed, and a progress bar corresponding to the process of deleting the print job may be displayed in a push notification area. If the predetermined application transmits the print job through a direct connection between the terminal apparatus 101 and the communication apparatus 151, the predetermined application may execute a process of returning the connection destination of the terminal apparatus 101 to an external access point. Then, a progress bar corresponding to the process of returning the connection destination of the terminal apparatus 101 to the external access point may be displayed in a push notification area. After the printing is completed, the communication apparatus 151 may execute a cleaning process, and a progress bar corresponding to the cleaning process may be displayed in a push notification area. As described above, a progress bar corresponding to preprocessing for the transmission of the print job or a progress bar corresponding to post-processing for the printing may be displayed in a push notification area.

The predetermined application may execute the push notification function at a timing other than the timing when the predetermined application receives an instruction to transmit a print job. Specifically, for example, if the predetermined application receives an instruction to issue an advertisement push notification from a server via the Internet, the predetermined application may issue an advertisement push notification based on information received from the server. At this time, the advertisement push notification is issued using a notification channel different from a notification channel corresponding to the transmission of a print job. In another push notification different from a push notification issued based on the reception of an instruction to transmit a print job, the push notification may not be issued by identifying the elements of ProgressStyle. That is, control may be performed so that the push notification is issued without using the progress-centric notifications function. In another push notification, a process of controlling notification content based on the version of the OS may not be executed. In other words, control may be performed so that in another push notification, the progress-centric notifications function is not used regardless of whether the version of the OS is 16 or higher.

Although in the above form, a single progress bar corresponding to the transmission of a print job or a single progress bar corresponding to printing is divided by placing marks, the present disclosure is not limited to this form. That is, control may be performed so that the predetermined application does not separate a single progress bar corresponding to the transmission of a print job using marks, but displays as many progress bars corresponding to the transmission of the print job as the number of pieces of print data included in the print job. Similarly, control may be performed so that the predetermined application does not separate a single progress bar corresponding to printing using marks, but displays as many progress bars corresponding to the printing as the number of pieces of print data included in the print job.

Although in the above description, a form has been employed in which in an area for displaying the job-related information on the application screen (FIGS. 6A to 6H), progress bars are not displayed, the present disclosure is not limited to this form. Progress bars may be displayed on the application screen similarly to the push notification areas displayed in a case where the version of the OS of the terminal apparatus 101 is the particular version or higher.

Although in the above description, a form has been employed in which an icon differs depending on the details of the error, the present disclosure is not limited to this form. That is, a form may be employed in which the same icon is displayed regardless of the details of the error. In this case, a general-purpose icon indicating an error is used as the icon. A form may be employed in which the same button for displaying a web manual is also displayed regardless of the details of the error. In this case, the web manual displayed in a case where the button is operated is a manual describing methods for resolving a plurality of errors.

Although in the above form, the terminal apparatus 101 includes an Android OS, and the predetermined application is an application for an Android OS, the present disclosure is not limited to this form. The OS included in the terminal apparatus 101 may be another OS, and the predetermined application may be an application for another OS so long as the OS has a function capable of controlling the content of a push notification as described above.

The purpose of the present disclosure is also achieved by supplying a storage medium recording a program code of software for achieving the functions of the above embodiments to a system or an apparatus and by a computer (or a CPU or a microprocessor unit (MPU)) of the system or the apparatus reading and executing the program code stored in the storage medium. In this case, the program code itself read from the storage medium achieves the functions of the above embodiments, and the storage medium storing the program code constitutes the present disclosure.

As the storage medium for supplying the program code, for example, a flexible disk, a hard disk, an optical disc, a magneto-optical disc, a Compact Disc Read-Only Memory (CD-ROM), a Compact Disc-Recordable (CD-R), a magnetic tape, a non-volatile memory card, a ROM, a Digital Versatile Disc (DVD), or the like can be used.

According to the present disclosure, it is possible to improve the visibility of a notification by a push notification function.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-055315, filed Mar. 28, 2025, which is hereby incorporated by reference herein in its entirety.

What is claimed is:

1. A non-transitory computer-readable storage medium storing a predetermined application program for causing a computer of an information processing apparatus to:
receive, from a printer, information regarding a state of printing based on a print job for causing the printer to execute printing; and
execute a predetermined notification process for displaying, via a push notification function, a notification area for issuing a notification indicating that the printing is being executed, the notification area including a progress bar corresponding to the printing,
wherein the predetermined notification process includes a process for displaying one or more marks on the progress bar corresponding to the printing so that the progress bar corresponding to the printing is divided into a number of parts equal to a number of pieces of print data included in the print job.

2. The non-transitory computer-readable storage medium according to claim 1, wherein the predetermined application program further causes the computer to perform control so that, in a case where the progress bar corresponding to the printing is divided into a plurality of parts including a first part and a second part through the process for displaying the one or more marks on the progress bar corresponding to the printing, an icon is displayed on the first part in a state where printing based on first print data included in the print job is being executed, and an icon is displayed on the second part in a state where printing based on second print data included in the print job is being executed.

3. The non-transitory computer-readable storage medium according to claim 1, wherein the predetermined notification process includes a process for cause the notification area to include a sentence indicating that the printing is being executed.

4. The non-transitory computer-readable storage medium according to claim 1, wherein the predetermined notification process includes a process for causing the notification area to include an area indicating a piece of print data, among pieces of print data included in the print job, on which the printing being executed is based on.

5. The non-transitory computer-readable storage medium according to claim 1,
wherein the predetermined application program further causes the computer to transmit the print job to the printer, and
wherein the predetermined application program performs control so that a progress bar corresponding to transmission of the print job is further displayed via the push notification function.

6. The non-transitory computer-readable storage medium according to claim 5, wherein the progress bar corresponding to the transmission of the print job is displayed in the notification area together with the progress bar corresponding to the printing.

7. The non-transitory computer-readable storage medium according to claim 5, wherein before the notification area including the progress bar corresponding to the printing is displayed, the progress bar corresponding to the transmission of the print job is displayed in another notification area different from the notification area including the progress bar corresponding to the printing.

8. The non-transitory computer-readable storage medium according to claim 5, wherein the predetermined application program executes a process for displaying one or more marks on the progress bar corresponding to the transmission of the print job so that the progress bar corresponding to the transmission of the print job is divided into a number of parts equal to the number of pieces of print data included in the print job.

9. The non-transitory computer-readable storage medium according to claim 8, wherein the predetermined application program further causes the computer to perform control so that, in a case where the progress bar corresponding to the transmission of the print job is divided into a plurality of parts including a first part and a second part through the process for displaying the one or more marks on the progress bar corresponding to the transmission of the print job, an icon is displayed on the first part in a state where first print data included in the print job is being transmitted, and an icon is displayed on the second part in a state where second print data included in the print job is being transmitted.

10. The non-transitory computer-readable storage medium according to claim 9, wherein the predetermined application program executes a process of performing control so that an icon displayed on the progress bar corresponding to the printing and an icon displayed on the progress bar corresponding to the transmission of the print job are different from each other.

11. The non-transitory computer-readable storage medium according to claim 5, wherein the predetermined application program executes a process of performing control so that a color of the progress bar corresponding to the printing and a color of the progress bar corresponding to the transmission of the print job are different from each other.

12. The non-transitory computer-readable storage medium according to claim 1, wherein the predetermined application program further causes the computer to execute a process for, in a case where an error has occurred in the printing, displaying, via the push notification function, a notification area indicating that an error has occurred.

13. The non-transitory computer-readable storage medium according to claim 12,
wherein the predetermined application program executes a process for displaying one or more marks on the progress bar corresponding to the printing so that the progress bar corresponding to the printing is divided into a number of parts equal to the number of pieces of print data included in the print job,
wherein the progress bar corresponding to the printing is divided into a plurality of parts including a first part and a second part through the process for displaying the one or more marks on the progress bar corresponding to the printing, and
wherein the predetermined application program performs control so that, in a case where an error has occurred in a state where the printing based on first print data included in the print job is being executed, an icon indicating an error is displayed on the first part, and in a case where an error has occurred in a state where the printing based on second print data included in the print job is being executed, an icon indicating an error is displayed on the second part.

14. The non-transitory computer-readable storage medium according to claim 13, wherein the predetermined application program performs control so that different icons are displayed on the progress bar corresponding to the printing depending on a detail of an error that has occurred in the printing.

15. The non-transitory computer-readable storage medium according to claim 12, wherein the predetermined application program performs control so that a color of the progress bar corresponding to the printing in a state where an error has not occurred and a color of the progress bar corresponding to the printing in a state where an error has occurred are different from each other.

16. The non-transitory computer-readable storage medium according to claim 1, wherein the predetermined application program performs control so that the progress bar corresponding to the printing is displayed using a progress-centric notifications function included in an Android OS a version of which is Android 16 or higher.

17. The non-transitory computer-readable storage medium according to claim 1,
wherein, in a case where the predetermined application program operates in another information processing apparatus including an Android OS a version of which is lower than Android 16, the predetermined application program causes a computer of the another information processing apparatus to execute another notification process for displaying, via a push notification function, a notification area for issuing a notification indicating that the printing is being executed, the another notification process being different from the predetermined notification process, and
wherein the another notification process does not include a process for displaying one or more marks on the progress bar corresponding to the printing so that the progress bar corresponding to the printing is divided into a number of parts equal to the number of pieces of print data included in the print job.

18. The non-transitory computer-readable storage medium according to claim 17, wherein the another notification process is a process for displaying, via the push notification function, a notification area not including the progress bar corresponding to the printing, or a process for displaying, via the push notification function, a notification area including the progress bar corresponding to the printing not divided by the marks.

19. The non-transitory computer-readable storage medium according to claim 1,
wherein the predetermined application program further causes the computer to execute a particular notification process for displaying, via a push notification function, a notification area for issuing a notification of an advertisement, and
wherein the predetermined application program performs control so that a progress bar is not included in the notification area for issuing a notification of an advertisement.

20. The non-transitory computer-readable storage medium according to claim 19, wherein the predetermined application program performs control so that the notification area for issuing a notification indicating that the printing is being executed is displayed using a progress-centric notifications function included in an Android OS a version of which is Android 16 or higher, and the predetermined application program performs control so that the notification area for issuing a notification of an advertisement is displayed without using the progress-centric notifications function.

21. A control method for an information processing apparatus including a predetermined application program, the control method comprising:
receiving, from a printer, information regarding a state of printing based on a print job for causing the printer to execute printing; and
executing a predetermined notification process for displaying, via a push notification function, a notification area for issuing a notification indicating that the printing is being executed, the notification area including a progress bar corresponding to the printing,
wherein the predetermined notification process includes a process for displaying one or more marks on the progress bar corresponding to the printing so that the progress bar corresponding to the printing is divided into a number of parts equal to a number of pieces of print data included in the print job.

22. An information processing apparatus including a predetermined application program, the information processing apparatus comprising:
at least one memory that stores a set of instructions; and
at least one processor that executes the instructions causing the information processing apparatus to perform operations comprising:
receiving, from a printer, information regarding a state of printing based on a print job for causing the printer to execute printing; and
executing a predetermined notification process for displaying, via a push notification function, a notification area for issuing a notification indicating that the printing is being executed, the notification area including a progress bar corresponding to the printing,
wherein the predetermined notification process includes a process for displaying one or more marks on the progress bar corresponding to the printing so that the progress bar corresponding to the printing is divided into a number of parts equal to a number of pieces of print data included in the print job.
